(19) United States
(12) Patent Application Publication
(10) Pub. No.: US 2005/0220446 A1
(43) Pub. Date: Oct. 6, 2005

(54) Ceiling apparatus and method of reducing condensation in controlled atomosphere buildings

(76) Inventor: Jerry K. Matson, Pasco, WA (US)

Correspondence Address: Floyd E. Ivey;Liebler, Ivey, Connor & Berry, P.O. Box 6125, Kennewick, WA, 99336, US

(21) Appl. No.: 10/817,347

(22) Filed: Apr. 2, 2004

(51) Int. Cl. H05B 3/28

(52) U.S. Cl. 392/437; 219/213

(57) ABSTRACT

An interior wall and interior ceiling apparatus and method for heating interior wall surfaces and interior ceiling surfaces for purposes of holding interior wall surfaces and interior ceiling surfaces above the drew point for the interior atmospheric conditions of food storage building. The interior wall and interior ceiling comprised of heat tape secured between at least two layers of insulating material including isocyanurate. The heat tape heats the interior wall and interior ceiling surfaces sufficiently to minimize condensation.

### FIELD OF THE INVENTION

The present invention relates generally to controlling and minimizing condensation on ceilings in buildings. The invention more particularly relates to the control and minimizing of the collection of condensation on ceilings of food storage buildings containing vegetables.

### BACKGROUND OF THE INVENTION

Many vegetables are stored in buildings with controlled atmospheres including circulation of the air for the purpose of retaining produce freshness or decreasing the time within which produce spoilage might occur. Air is forced through vents located within the floor and circulates through the stored fruits or vegetables. The controlled atmosphere is generally very humid creating an opportunity for collection of condensate at the ceiling leading to condensate water dripping upon and entering the bulk stored vegetable pile. The control and minimizing of condensation inside the controlled atmosphere building is a recognized industry problem and requirement for successful long term storage. Condensation will form on the walls and ceiling of the controlled atmosphere building when the ceiling or wall surface temperature drops below the temperature of the building interior. Prior art directed to minimizing the formation of condensation in controlled atmosphere buildings is seen in U.S. Pat. No. 5,353,564 to Hansen.

### SUMMARY OF THE INVENTION

The controlled atmosphere building (20) interior ceiling (32) and interior walls (40) are subject to collection of condensation at the interior ceiling surface (34) and the interior wall surface (42). Maintaining the temperature of the interior wall surface (42) and interior ceiling surface (34) at or above the temperature of the building interior (22) will eliminate or minimize the collection of condensation. This is accomplished by composing the interior walls (40) and or the interior ceiling (32) of or affixing to the existing building walls and or ceiling a heating means (60) interposed between a first insulating board means (7) and a second insulating board means (14). The combined first insulating board means (7), interposed heating means (60) and second insulating board means (14) either form the surface of the interior ceiling (32) or interior wall (42) or are affixed to the existing interior building ceiling surface (32) and or interior wall (42) such that the exterior surface (4) of the structure forms the surfaces of the interior wall (40) and or interior ceiling (32). Heating means (60) is controlled to allow heating of the indicated first insulating board means (7) and second insulating board means (14) and specifically the second insulating board means (14) at the exterior surface (4). Heating means (60) is controlled to maintain the exterior surface (4) at or above the temperature of the building interior (22).

### BRIEF DESCRIPTION OF DRAWINGS

FIG. 1 is a perspective of a controlled atmosphere building (20) showing a cutaway of the wall (40) and ceiling (32). Also illustrated is bulk storage of vegetables (70).

FIG. 2 is a section from FIG. 1 showing a building (20) walls (40) and ceiling (32) and the apparatus of this patent (1) comprising a heating means (60) interposed between a first insulating board means (7) and a second insulating board means (14).

FIG. 3 and FIG. 4 are details from FIG. 2 showing the invention including a heating means (60) interposed between a first insulating board means (7) and a second insulating board means (14). Additionally illustrated is power means (65) for the heating means (60).

FIG. 5 and FIG. 6 are sections from FIG. 3 which illustrate, for the ceiling at FIG. 5 and for the wall application at FIG. 6, the serpentine or sinusoidal arrangement and dimensions of the heating means (60) relative to the at least one insulating board means (7). Also seen is power means (65) and temperature control means (70) and temperature sensing means (75). FIG. 5 illustrates

### DETAILED DESCRIPTION OF THE INVENTION

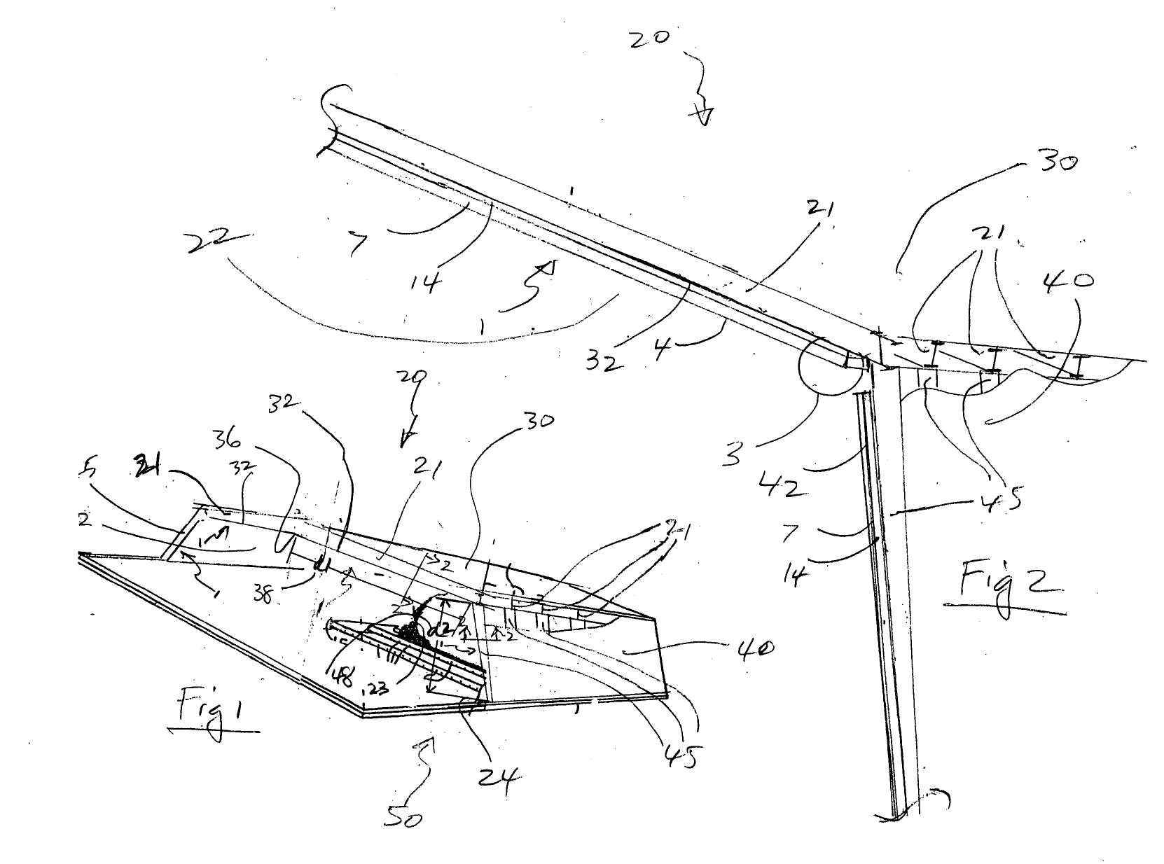

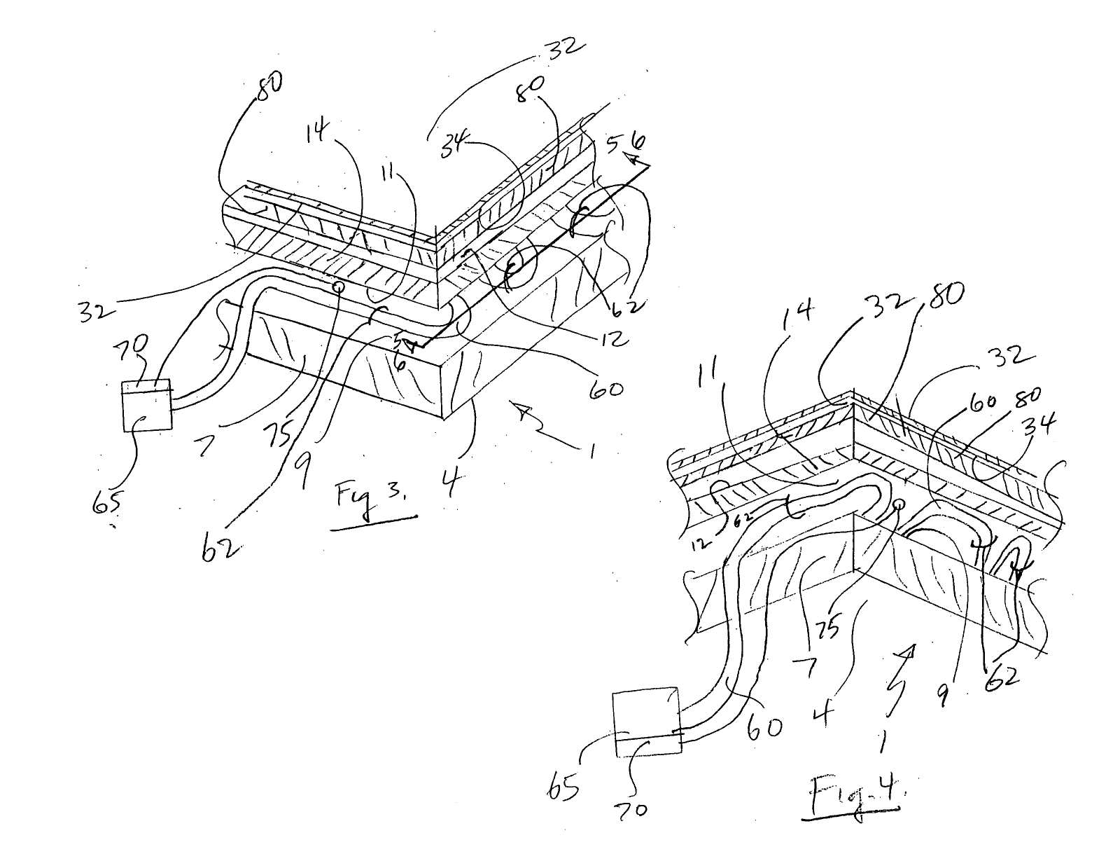

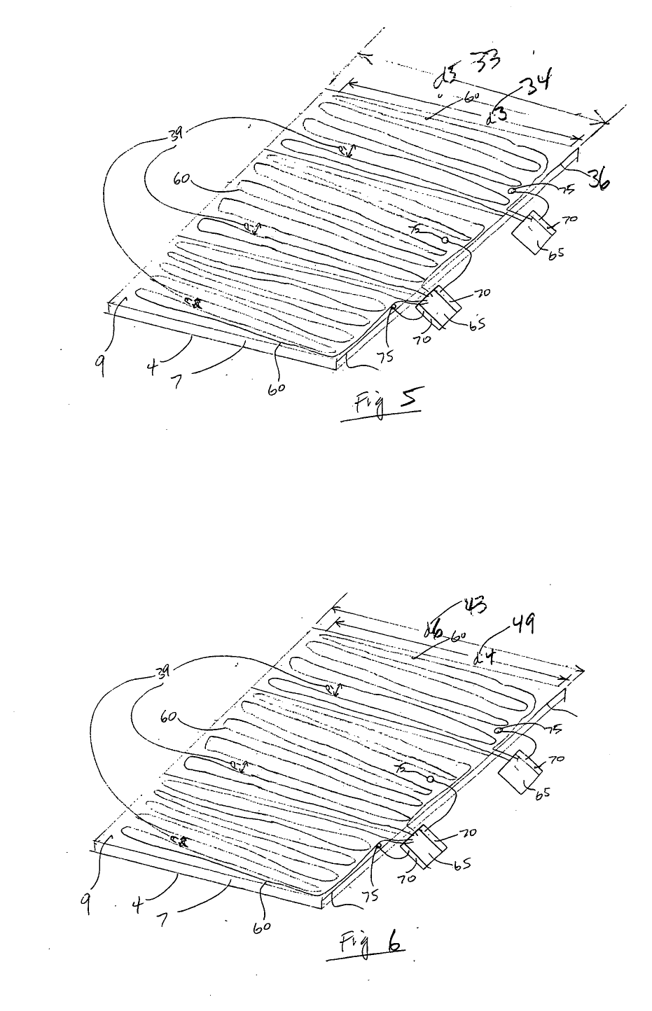

FIGS. 1, 2, 3, 4, 5 and 6 illustrates a food storage controlled atmosphere building (20) having an interior (22) which is subject to the accumulation of condensation. The controlled atmosphere building (20) illustration omits air handling equipment normally utilized in such facilities. This invention focuses on maintaining the building interior surfaces at a temperature, approximately 0.5 degrees F., above the dewpoint of the food storage building interior (22) to prevent the accumulation of condensation on these surfaces. Accumulation of condensation on the building ceiling (32) allows the condensate to drip onto and into bulk stored vegetables such as potatoes causing or contributing to deterioration.

The apparatus and method of this invention comprises at least one insulating board means (7) having a first top surface (9) and an exterior surface (4); the exterior surface (4) is in atmosphere communication with the interior of a building (20). The building (20) has a ceiling (32) and walls (40). The ceiling (32) has an apex (36) and a width d1 (38) from the ceiling apex (36) to a wall (40). The wall (40), having an interior wall surface (42), has a height d2 (48) from a building foundation (24) to the ceiling (32). A heating means (60) is in thermal communication with and affixed by heating means (60) affixing means (62) to the first top surface (9). The first top surface (9) is affixed by construction means to a ceiling (32) at an interior ceiling surface (34). The at least one insulating board means (7) has a width d5 (33) which is less than or equal to the ceiling width d1 (38). The apparatus, at the wall (40), is affixed, at the first top surface (9), by construction means to a wall (40) at an interior wall surface (42) and where the at least one insulating board means (7) has a height d6 (43) which is less than or equal to the wall (40) height d6 (43). A power means (65) is connected by power interconnection means (64) with the heating means (60) to operate the heating means (60) and temperature control means (70) is provided to control the power mans (65) for temperature control of the heating means (60).

The preferred embodiment has is composed of a first insulating board means (7) having a first top surface (9) and an exterior surface (4) and a second insulating board means (14) having a bottom surface (11) and a second top surface (12). The exterior surface (4) is moisture resistant. The at least one insulating board means (7), the first insulating board means (7) and second insulating board means (14) is comprised, in the preferred embodiment of polyisocyanurate rigid insulation board having a moisture resistant surface. Insulating board means (7) may be substantially planar. Other insulation materials will be recognized as equivalent.

In the preferred embodiment the heating means (60) is 220v heat tape (60) controlled by a temperature control means (70) comprising thermostatic control with temperature sensing by a temperature sensing means (75) generally provided by a thermocouple or thermistor placed distal from the heating means (60) at the a first top surface (9) or bottom surface (11). In an alternative embodiment the heating means (60) may be a fluid heat transfer system means (60) comprised of tubing conducting fluids having fluid temperature controlled by a temperature control means (70) comprising thermostatic control with temperature sensing by a temperature sensing means (75) operating valves and pumps for the delivery of temperature controlled fluids. The heating means (60) is affixed by heating means affixing means (62) at the first top surface (9) or bottom surface (11) which includes but is not limited to adhesives, staples, tapes, sheet metal screws and other recognized equivalent affixing means. In the preferred embodiment a single temperature measurement, via a temperature sensing means (75) is provided for temperature control means (70) operation with temperature control operated or adjusted manually by a building manager upon inspection of interior ceiling surfaces (34) and interior wall surfaces (42).

In the preferred embodiment the at least one heating means (60) is arranged, relative to the ceiling (32), at the first top surface (9) or the bottom surface (11) in a serpentine or sinusoidal arrangement. At the ceiling (32), the serpentine or sinusoidal arrangement having a period p1 (39) and an amplitude d3 (34) of a width less than or equal to the ceiling width d1 (38). At the wall the at least one heating means (60) is arrangement in a serpentine or sinusoidal arrangement, having a period p1 (39) and an amplitude d4 (49) of a height less than or equal to the height d2 (48) of the wall (40) at the interior wall surface (42).

In the preferred embodiment the first insulating board means (7), at the first top surface (9), is affixed by insulating board affixing means flush to the second insulating board means (14) at the bottom surface (11) such that there is no cavity or such that any space between the said first insulating board means (7) and the second insulating board means (14) is minimized. Insulating board affixing means comprises adhesives, staples, screws and other means recognized by those of ordinary skill in insulation arts. The second top surface (12) is affixed by construction means to a ceiling (32) at an interior ceiling surface (34) or to a wall (40) at an interior wall surface (42). Construction affixing means includes but is not limited to staples, screws, adhesives and other equivalent affixing means. In the preferred embodiment a ceiling insulation means (80) is placed intermediate the second insulating board means (7) at the second top surface (12) and the interior ceiling surface (34). Ceiling insulation means (80) is blown, glass-blanket, foam and other insulation as will be appreciated by those of ordinary skills in the insulation arts.

The method of heating controlled atmosphere ceilings and or walls is by affixing at least one insulating board means (7) at a ceiling (32) and or a wall (40) of an interior (22) of a building (20) where the ceiling (32) has an apex (36) and a width d1 (38) from the ceiling apex (36) to the wall (40). The wall (40), at an interior wall surface (42) having a height d2 (48) from a building foundation (24) to the ceiling (32). The at least one insulating board means (7) having a first top surface (9) and an exterior surface (4) and the exterior surface (4) is in atmosphere communication with the interior (22). Heating the at least one insulating board means (7) with a heating means (60) in thermal communication with and affixed by heating means (60) affixing means (62) to the first top surface (9). Affixing by construction means, the first top surface (9) to a ceiling (32) and or a wall (40); affixing the first top surface (9) to a ceiling (32) at an interior ceiling surface (34) where the at least one insulating board means (7) having a width d5 (33) which is less than or equal to the ceiling width d1 (38); affixing the first top surface (9) to a wall (40) at an interior wall surface (42) with the at least one insulating board means (7) having a height d6 (43) which is less than or equal to the wall (40) height d6 (43). Supplying power means (65) connected by power interconnection means (64) with heating means (60) to operate the heating means (60) and providing temperature control means (70) to control the power mans (65) for temperature control of the heating means (60).

In the preferred embodiment Thermax rigid foam board by Celotex® is used as solid core insulation board which does not absorb moisture. Typical construction is two sets of 716′ resistance/heat cables at approximately 2 kw each wired to a single 220v 4 kw breaker. Heat cables are looped in a serpentine or sinusoidal arrangement from building side to side with an approximate 2′ period. Two sets of cables will heat approximately 24′ of building ceiling. The heating means comprised of heat cables are controlled by a thermostat with the sensor, typically a thermocouple or thermistor, between the Thermax boards. Operations typically call for the temperature between the Thermax boards to be maintained approximately 1 to 2 degrees above the temperature of the building interior. The building manager will observe and will adjust the thermostat to increase the temperature if any condensation is observed. The construction is two layers of Thermax with a blown in layer of R32 on the top giving approximately R40 above the heat tape. This allows the heat tape to maintain the temperature of the bottom board such that the interior surface is maintained at approximately 0.5 degrees over the building interior temperature.

1. A Ceiling or Wall Apparatus for Reducing Condensation in Controlled Atmosphere Buildings comprising:
a. at least one insulating board means (7) having a first top surface (9) and an exterior surface (4); the exterior surface (4) in atmosphere communication with the interior of a building (20); the building having a ceiling (32) with an apex (36) and a width d1 (38) from the ceiling apex (36) to a wall (40); the wall (40) at an interior wall surface (42) having a height d2 (48) from a building foundation (24) to the ceiling (32);
b. at least one heating means (60) in thermal communication with and affixed by heating means (60) affixing means (62) to the first top surface (9);
c. the first top surface (9) affixed by construction means to a ceiling (32) and or to a wall (40); where to a ceiling (32) at an interior ceiling surface (34); the at least one insulating board means (7) having a width d5 (33) which is less than or equal to the ceiling width d1 (38); where to a wall (40) at an interior wall surface (42); the at least one insulating board means (7) having a height d6 (43) which is less than or equal to the wall (40) height d2 (48);
d. at least one power means (65) connected by at least one power interconnection means (64) with the at least one heating means (60) to operate the at least one heating means (60) and at least one temperature control means (70) to control the at least one power mans (65) for temperature control of the at least one heating means (60).

2. A Ceiling or Wall Apparatus for Reducing Condensation in Controlled Atmosphere Buildings of claim 1 further comprising:
a. the at least one insulating board means (7) comprised of a first insulating board means (7) having a first top surface (9) and an exterior surface (4) and a second insulating board means (14) having a bottom surface (11) and a second top surface (12); the exterior surface (4) is moisture resistant;
b. the at least one heating means (60) affixed by heating means (60) affixing means (62) to the first top surface (9) or the bottom surface (11);
c. the first top surface (9) affixed by insulating board affixing means to the bottom surface (11);
d. the second top surface (12) affixed by construction means to a ceiling (32) at an interior ceiling surface (34) or to a wall (40) at an interior wall surface (42).

3. A Ceiling or Wall Apparatus for Reducing Condensation in Controlled Atmosphere Buildings of claim 2 further comprising:
a. the at least one insulating board means (7) comprising the first insulating board means (7) and the second insulating board means (14) is composed of insulation board;
b. ceiling insulation means (80) intermediate the second insulating board means (7) at the second top surface (12) and the interior ceiling surface (34).

4. A Ceiling or Wall Apparatus for Reducing Condensation in Controlled Atmosphere Buildings of claim 3 further comprising:
a. the at least one heating means (60) composed of heat tape (60) or a fluid heat transfer system means (60);
b. the at least one power means (65) composed of electrical power (65) or fluid heat means;
c. the at least one temperature control means (70) composed of thermostatic control means (70) having at least one temperature sensing means (75) received between at the first top surface (9) or between the first top surface (9) and the bottom surface (11) and in temperature control communication with the power means (65).

5. A Ceiling or Wall Apparatus for Reducing Condensation in Controlled Atmosphere Buildings of claim 4 further comprising:
a. the at least one heating means (60) composed of heat tape (60) or a fluid heat transfer system means (60) arranged, at the ceiling (32) to the first top surface (9) or the bottom surface (11); to the first top surface (9) or the bottom surface (11) in a serpentine or sinusoidal arrangement;
b. the at least one heating means (60), at the ceiling (32), having a period p1 (39) and an amplitude d3 (34) of a width less than or equal to the ceiling width d1 (38); the heating means (60), at the wall (40), having a period p1 (39) and an amplitude d4 (49) of a height less than or equal to the height d2 (48) of the wall (40) at the interior wall surface (42);
c. insulation board is rigid insulation board; the first top surface (9) affixed flush against the bottom surface (11) such as to minimize space between said first top surface (9) and the bottom surface (11).

6. A Method for Reducing Ceiling or Wall Condensation in Controlled Atmosphere Buildings of by use of the Apparatus of claim 1 further comprising:
a. affixing at least one insulating board means (7) at a ceiling (32) and or a wall (40) of an interior (22) of a building (20); the ceiling (32) having an apex (36) and a width d1 (38) from the ceiling apex (36) to the wall (40); the wall (40) at an interior wall surface (42) having a height d2 (48) from a building foundation (24) to the ceiling (32); the at least one insulating board means (7) having a first top surface (9) and an exterior surface (4); the exterior surface (4) in atmosphere communication with the interior (22);
b. heating the at least one insulating board means (7) with a heating means (60) in thermal communication with and affixed by heating means (60) affixing means (62) to the first top surface (9);
c. affixing by construction means, the first top surface (9) to a ceiling (32) and or a wall (40); affixing the first top surface (9) to a ceiling (32) at an interior ceiling surface (34) where the at least one insulating board means (7) having a width d5 (33) which is less than or equal to the ceiling width d1 (38); affixing the first top surface (9) to a wall (40) at an interior wall surface (42) with the at least one insulating board means (7) having a height d6 (43) which is less than or equal to the wall (40) height d6 (43);
e. supplying power means (65) connected by power interconnection means (64) with heating means (60) to operate the heating means (60) and providing temperature control means (70) to control the power mans (65) for temperature control of the heating means (60).

7. A Method for Reducing Ceiling or Wall Condensation in Controlled Atmosphere Buildings of by use of the Apparatus of claim 6 further comprising:
a. forming the at least one insulating board means (7) of a first insulating board means (7) having a first top surface (9) and an exterior surface (4) and a second insulating board means (14) having a bottom surface (11) and a second top surface (12); the exterior surface (4) is moisture resistant;
b. affixing the heating means (60) by heating means (60) affixing means (62) to the first top surface (9) or the bottom surface (11);
c. affixing the first top surface (9) by insulating board affixing means to the bottom surface (11);
d. affixing the second top surface (12) by construction means to a ceiling (32) at an interior ceiling surface (34) or to a wall (40) at an interior wall surface (42).

8. A Method for Reducing Ceiling or Wall Condensation in Controlled Atmosphere Buildings of by use of the Apparatus of claim 7 further comprising:
a. forming the at least one insulating board means (7) comprising the first insulating board means (7) and the second insulating board means (14) of insulation board;
b. adding ceiling insulation means (80) intermediate the second insulating board means (7) at the second top surface (12) and the interior ceiling surface (34).

9. A Method for Reducing Ceiling or Wall Condensation in Controlled Atmosphere Buildings of by use of the Apparatus of claim 8 further comprising:
a. providing insulation board of polyisocyanurate rigid insulation board;
b. providing heating means (60) composed of heat tape (60) or a fluid heat transfer system means (60);
b. providing power means (65) composed of electrical power (65) or fluid heat means;
c. providing temperature control means (70) composed of thermostatic control means (70) having a temperature sensing means (75) received between at the first top surface (9) or between the first top surface (9) and the bottom surface (11) and in temperature control communication with the power means (65).

10. A Method for Reducing Ceiling or Wall Condensation in Controlled Atmosphere Buildings of by use of the Apparatus of claim 9 further comprising:
a. arranging the heating means (60) composed of heat tape (60) or a fluid heat transfer system means (60), at the ceiling (32) to the first top surface (9) or the bottom surface (11); to the first top surface (9) or the bottom surface (11) in a serpentine or sinusoidal arrangement;
b. establishing the arrangement of the heating means (60), at the ceiling (32), to have a period p1 (39) and an amplitude d3 (34) of a width less than or equal to the ceiling width d1 (38);
c. establishing the arrangement of the heating means (60), at the wall (40), having a period p1 (39) and an amplitude d4 (49) of a height less than or equal to the height d2 (48) of the wall (40) at the interior wall surface (42).
